(19) United States
(12) Patent Application Publication
(10) Pub. No.: US 2013/0105679 A1
(43) Pub. Date: May 2, 2013

(54) DUAL GAMMA RAY AND NEUTRON DETECTOR IN A MULTI-SENSOR APPARATUS AND RELATED METHODS

(71) Applicant: Helene Claire CLIMENT, Sugar Land, TX (US)

(72) Inventor: Helene Claire CLIMENT, Sugar Land, TX (US)

(73) Assignee: GE ENERGY OILFIELD TECHNOLOGY, INC., Broussard, LA (US)

(21) Appl. No.: 13/284,365

(22) Filed: Oct. 28, 2011

(51) Int. Cl. G01V 5/10; G01V 5/04

(52) U.S. Cl. 250/269.2; 250/265

(57) ABSTRACT

A downhole tool with two detectors located at different distances from a neutron source, has at least one dual gamma ray and neutron detector that includes a first detection element made of a neutron detector material, and a second element made of a gamma ray scintillation material, the first detection element and the second detection element being optically connected to a photomultiplier.

### BACKGROUND

1. Technical Field

Embodiments of the subject matter disclosed herein generally relate to packaging options of a dual gamma-ray and neutron detector to obtain a small rugged device useable in a multi-sensor apparatus to measure, for example, porosity of a formation surrounding a well in oil and gas industry.

2. Discussion of the Background

During the past years, more and more complex methods and tools have been developed for searching for and exploiting harder accessible (deeper in the ground and/or subsea) locations that appear to hold vast reserves of fossil fuel. The tools used to investigate these locations have to be able to withstand high temperatures and a harsh shock and vibration environment.

In the oil and gas industry, measurements of formation porosity and density are used to identify potential oil and gas reserves as well as to estimate the volume of the reserve. These type of measurements are traditionally performed in a well using radiation source (chemical or electronic) and detectors. The radiation source maybe a gamma ray or a neutron source. Gamma rays produced by the interaction of neutrons in the formation may be used as a gamma ray source. Some radioisotopes, such as californium, emit both neutron and gamma rays and maybe used as sole source for both radiations.

FIG. 1 illustrates a down-hole porosity or density measurement performed using a radiation source 10 and two detectors, a “near” detector 20 and a “far” detector 30, which are located at different distances from the source 10 (e.g., 6″ and 15″, respectively). The neutron source 10 emits fast neutrons in the formation surrounding the borehole. The neutron source 10 and the detectors 20 and 30 may be encapsulated in a chassis 40 to be lowered in a borehole 50 that penetrates a formation 60. Some of the neutrons emitted by the neutron source 10 towards the soil formation 60, loose energy (i.e., are “thermalized”) through inelastic collisions within the formation 60 and are deflected back towards the detectors 20 and 30. The detectors 20 and 30 detect some of the thermal neutrons that return to the borehole 50, when the neutrons react with nuclei inside a neutron detector material. The porosity of formation 60 may be estimated based on the ratio of neutrons detected during the same time interval by the two detectors 20 and 30. In the case of density measurements, the detector the closer to the gamma ray source is called the short spacing detector, the one the farther from the source is called the long spacing. The radiation particles coming back to the detectors are counted. The bulk density of the formation (matrix and fluid) is correlated with the electron density and derived from the short spacing and long spacing detector count rates.

Neutron being a neutral (no electrical charge) particle, it is not easy to be detected particularly when its energy is large. However, there are neutron detector materials capable to detect thermalized neutrons, that is, neutrons whose energy has been lowered through inelastic collisions with formation nuclei. For example, neutrons emitted by an AmBe around 14 MeV are thermalized down to an energy of about 0.025 eV.

A neutron detector's efficiency is the likelihood a neutron entering the detector's volume to be detected. The probability of a capture reaction of a neutron by a nucleus can be described by a cross-section of the reaction and it depends of the incoming neutron's energy. The neutron detectors are built from materials including nuclei that have a large cross-section of the neutron capture reaction for thermal neutrons, such as, boron (¹⁰B), helium (³He), and lithium (⁶Li). Other particles such as, the α particle (₂⁴α) and the proton (₁¹p) result from the reaction of the thermal neutron with these nuclei.

A calculable amount of energy (Q) is emitted as a result of the neutron capture reaction. This emitted energy may be kinetic energy of the resulting particles or gamma rays (photons, light). This energy is dissipated, for example, when neutron capture reaction by-products pass through a scintillating material causing emission of light. At least some of the light emitted following a neutron capture reaction reaches a photomultiplier (PMT), and generates a signal recognizable as a signature of the reaction. The larger is the emitted energy, the larger is the amplitude of the signature signal. The neutron capture reactions used for neutron detection are illustrated in Table 1:

TABLE 1

| | | | Thermal neutron |
|---|---|---|---|
| Name | Reaction | Q (MeV) | cross section (barns) |
| ¹⁰ B(n,α) | ₅¹⁰ B + ₀¹n→₃⁷ Li + ₂⁴ α | Ground 2.792 | 3840 |
| | | Excited 2.31 | |
| ³ He(n , p) | ₂³ He + ₀¹n→₁³ H + ₁¹p | 0.764 | 5330 |
| ⁶ Li(n,α) | ₃⁶ Li + ₀¹n→₁³ H + ₂⁴ α | 4.78 | 940 |

Traditionally, in the oil and gas industry, down-hole tool detectors included detectors based on ³He(n, p) reaction due to their relatively low cost, ruggedness, good detection efficiency, and insensitivity to gamma rays (i.e., the cross section for an interaction of the gamma ray with ³He is very small). The critical worldwide shortage of ³He makes it necessary to develop new neutron detectors for down-hole tool detectors for the oil and gas industry.

Lithium-glass scintillation detectors may be used in down-hole tools. The detection efficiency of the detector materials based on ⁶Li(n, α) reaction depends on the amount of ⁶Li therein. Although the cross section for an interaction of the neutron with ⁶Li is smaller than the cross section for an interaction with ³He, the large amount of energy (Q) resulting from the ⁶Li(n, α) reaction enables a good discrimination from reactions induced by gamma rays.

Currently, two models of lithium glass detectors are commercially available. FIG. 2 illustrates the first model 100, which is a near detector including a cylinder 110 having a diameter of 0.5″ and a length of 1″ and made of KG2 glass. KG2 glass is a neutron detector material that has an isotopic ratio of 95% ⁶Li and a total lithium composition of 7.5%.

A commercially available far detector includes a hollow cylinder having a 0.905″ diameter, a length 2.5″ and a thickness 0.0885″ made of GS20 glass. GS20 glass is a neutron detector material that has an isotopic ratio of 95% ⁶Li and a total lithium composition of 7.5%. The shape of GS20 glass is a hollow cylinder to eliminate gamma ray counts, which are proportional to the volume of the glass, while neutron counts are roughly proportional to surface area.

Both the near and the far detectors may use Hamamatsu R3991 photomultipliers (PMTS), e.g., 120 in FIG. 2, that have a ¾″ diameter photocathode. The hollow cylinder may be coupled to the PMT photocathode through a quartz light guide to adjust for the difference in diameters. A quartz disk may be mounted at an opposite end of the hollow cylinder.

One approach to building detectors for a down-hole tool may be using a neutron detector material in conjunction with a gamma-ray detector material. However, packaging of the neutron detector material with the gamma-ray detector material is a challenge, particularly when the detector is to be used in high temperature and harsh shock and vibration environment. The coefficient of thermal expansion of the neutron detector material may differ significantly from that of the gamma ray detector material causing cracks to appear between elements built from the different materials or inside an element, when the temperature varies significantly (e.g., over 50° C.) as the detector is lowered down-hole.

Accordingly, it would be desirable to provide packaging options for manufacturing a dual gamma-ray and neutron detector capable to operate at high temperature and in a harsh shock and vibration environment, using a neutron detector material and a gamma-ray detector material.

### SUMMARY

Dual gamma ray and neutron detectors packaged to withstand high temperature in a harsh shock and vibration environment are provided. These detectors may be used in oil and gas industry, homeland security, health-care, radiation protection, etc.

According to one exemplary embodiment, a dual gamma ray and neutron detector useable in a downhole tool for investigating composition of formation layers in a well is provided. The dual gamma ray and neutron detector includes a first detection element made of a neutron detector material, a second element made of a gamma ray scintillation material and a photomultiplier optically connected to the first detection element and the second detection element. In this embodiment, the first detection element and the second detection element are formed to substantially fill a cylindrical shape.

According to another exemplary embodiment, a downhole tool using a neutron source to determine characteristics of a formation surrounding a well has a body configured to receive along a longitudinal axis (1) a neutron source that emits neutrons, (2) a near detector located at a first distance from a location of the neutron source, and a far detector located at a second distance larger than the first distance from the location of the neutron source. The downhole tool further includes at least one dual gamma ray and neutron detector serving as the near detector or as the far detector having a first detection element made of a neutron detector material, and a second element made of a gamma ray scintillation material, the first detection element and the second detection element being optically connected to a photomultiplier.

According to another exemplary embodiment, a method for retrofitting a downhole tool using a neutron source to determine characteristics of a formation surrounding a well is provided. The method includes (A) removing at least one of a near detector and a far detector from a chassis of the downhole tool, and (B) mounting a dual gamma ray and neutron detector in the chassis at a location from which of the at least one of the near detector and the far detector has been removed. Here, the dual gamma ray and neutron detector includes a first detection element made of a neutron detector material, and a second element made of a gamma ray scintillation material, the first and the second detection element being optically connected to a photomultiplier and being formed to substantially fill a cylindrical shape.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a down-hole tool using a neutron source and two detectors;

FIG. 2 is an illustration of a commercially available near neutron detector;

FIG. 3 is a schematic diagram of a down-hole tool, according to an exemplary embodiment;

FIG. 4 is an exemplary illustration of a spectrum recorded by a photomultiplier connected to a gamma rays and neutron detector;

FIG. 5 is a dual gamma ray and neutron detector, according to an exemplary embodiment;

FIG. 6 is a dual gamma ray and neutron detector, according to another exemplary embodiment;

FIG. 7 is a dual gamma ray and neutron detector, according to another exemplary embodiment; and

FIG. 8 is a flow chart of a method for retrofitting a downhole tool using a neutron source to determine characteristics of a formation surrounding a well, according to an exemplary embodiment.

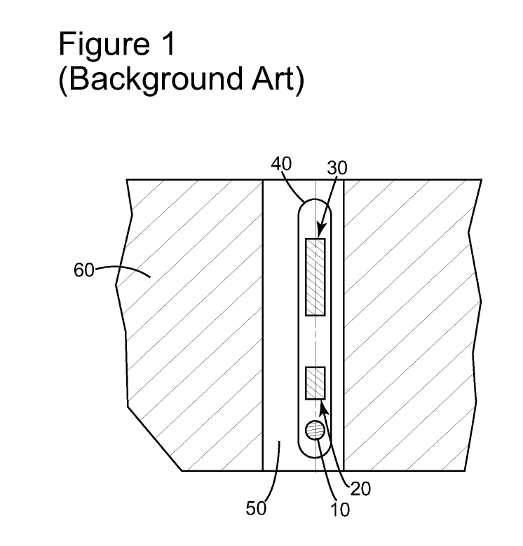

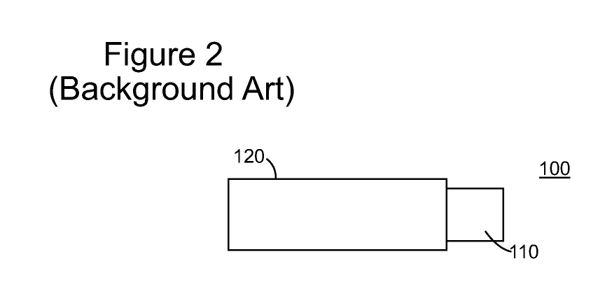

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of down-hole tools including particle detectors. However, the embodiments to be discussed next are not limited to these tools, but may be applied to other tools that require compact rugged detectors.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

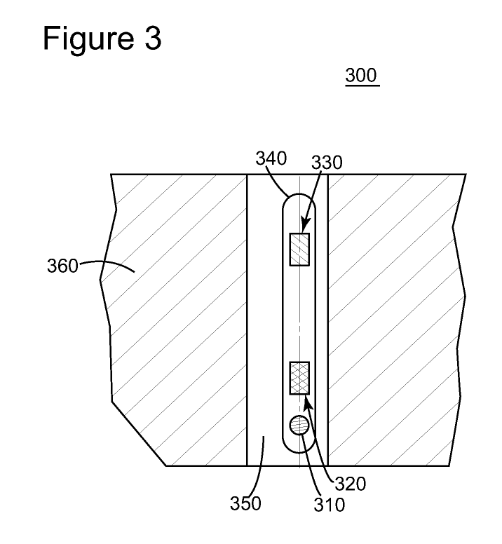

FIG. 3 illustrates a down-hole tool 300 according to an exemplary embodiment. Neutrons emitted from a neutron source 310 and thermalized via inelastic scattering with nuclei in the surrounding formation 360 are detected in two detectors, a “near” detector 320 and a “far” detector 330, which are located at different distances from the neutron source 310. The “near” detector 320 and/or the “far” detector 330 are manufactured using a neutron detector material in conjunction with a gamma-ray scintillation material arranged according to one of the packaging options described below. This type of detector that is made of a neutron detector material and a gamma-ray scintillation material is known as a dual gamma ray and neutron detector. The downhole tool 300 may be used, for example, for measurements of porosity and density of the formation surrounding a well.

In some embodiments the gamma ray scintillation material may be sodium iodide or another scintillation crystal, and the neutron detector material may be lithium-6 enriched glass. The coefficients of thermal expansion of material used in building the detectors are listed in the following Table 2. If the difference between the coefficients of thermal expansion of the ⁶Li glass and the scintillation crystal is large, cracks there-between occurs when the temperature increases (e.g., over 50° C.).

TABLE 2

| Material | Coefficient of Thermal Expansion |
|---|---|
| Sodium Iodide, NaI | 4.72 × 10⁻⁵ m/° C. |
| Lanthanum Hallides | 1.2 ×10⁻⁵ m/° C. |
| Lithium Glass | 9.23 ×10⁻⁶ m/° C. |
| Glass | 9 ×10⁻⁶ m/° C. |
| Quartz | 0.59 ×10⁻⁶ m/° C. |

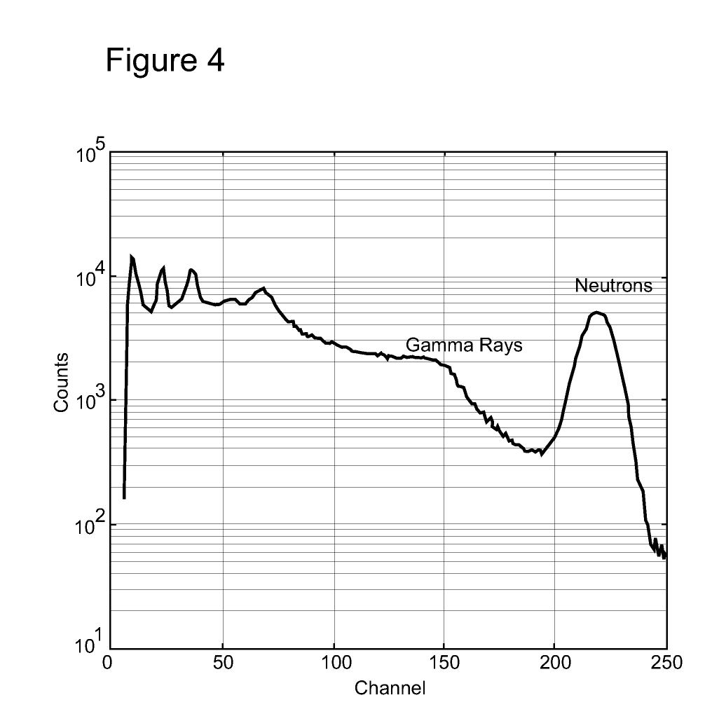

The detectors 320 and 330 detect some of the thermal neutrons that return to the borehole 350, when the neutrons react with nuclei inside the neutron detector material. The gamma rays, which are also detected by detectors 320 and 330, are separated and removed from signals detected by the detectors 320 and 330, based on the fact that a signal generate by a gamma ray has lower pulse height that a neutron signature signal. FIG. 4 exemplarily illustrates a spectrum recorded by a photomultiplier connected to a gamma rays and neutron detector.

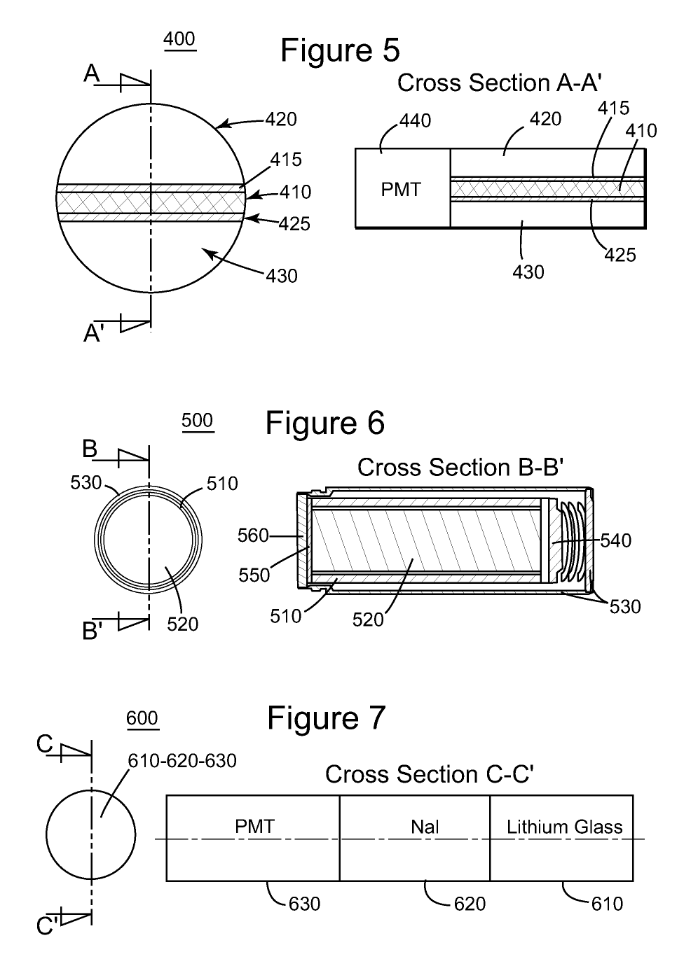

A first packaging option for the neutron detector material and the gamma-ray scintillation material is illustrated in FIG. 5. This first packaging option is known as “the sandwich design.” According to this sandwich design, a plate 410 made of neutron detector material is placed between two half cylinders 420 and 430, respectively, made of gamma-ray scintillation material. Layers of coupling oil or bond 415 and 425 are disposed at an interface between the plate 410 and the half cylinders 420 and 430, respectively. Both the plate 410 and the half cylinders 420 and 430 are optically connected to the photomultiplier 440 (using optical oil, a sapphire window or bonded to the PMT with a high temperature glue such as sylgard).

In an alternative embodiment, an additional half-plate may be placed perpendicular to the plate splitting in the middle one of the half cylinders. In some embodiments the plate 410 may be made of ⁶Li glass. In some embodiments the half cylinders 420 and 430 may be made of NaI or another scintillation material (e.g., lanthanum halides).

A second packaging option for the neutron detector material and the gamma-ray scintillation material is illustrated in FIG. 6. This second packaging option is known as “the corndog design.” According to this corndog design, a hollow cylinder 510 made of neutron detector material filled with a rod (i.e., cylinder) 520 made of a gamma-ray scintillation material.

Some optional constructive features illustrated in FIG. 6 and described below may be used for dual gamma ray and neutron detectors using the other packaging options than the corndog design and are not intended to be limiting. The cylinder 510 may be encased in a metallic shell 530. The housing may hold both the reactive material, lithium-6 or NaI, and the suspension mechanism to provide high shock and vibration resistance. The metallic shell 530 may be made of titanium.

At one end of the filled cylinder (i.e., the hollow cylinder 510 with the rod 520 inside), towards the neutron source location, a stainless steel disk holds the reactive material in place in the housing. Between the metallic disk and the housing, springs provide suspension. At the opposite end of the filled cylinder, towards a PMT (not shown), one or more light guiding materials optically connect the detecting elements (i.e., the hollow cylinder 510 and the rod 520) to the PMT. For example, a sylgard coupler 550 and a sapphire end plate 560 may be located between the detecting elements and the PMT.

In order to ensure that most of the light does not dissipate without generating a signal, an end quartz plate 540 may be placed between the metallic shell 530 and the detecting elements.

In some embodiments the hollow cylinder 510 may be made of ⁶Li glass. In some embodiments the rod 520 may be made of NaI. Additionally, in some embodiments, a teflon wrapping of the detecting elements serves as a reflective coat.

A third packaging option for the neutron detector material and the gamma-ray scintillation material is illustrated in FIG. 7. This third packaging option is known as “the in-line design.” According to this in-line design, first cylinder 610 made of neutron detector material is arranged on the same axis with a cylinder 620 made of a gamma-ray scintillation material, which is then in contact to a PMT 630.

In some embodiments the cylinder 610 may be made of ⁶Li glass. In some embodiments the cylinder 620 may be made of NaI. Optical ray-trace simulations have shown that NaI is transmits light better than ⁶Li glass, and, thus, the arrangement PMT-NaI-⁶Li glass is preferred to PMT-⁶Li glass-NaI.

Monte-Carlo simulations have been performed for all the above-described design options. The simulations have shown that a ⁶Li glass plate and an equivalent surface ⁶Li glass cylinder provide adequate neutron counting rates for a neutron detector useable in down-hole tools.

Other useful conclusions resulting from simulations are listed below. Although these conclusions may need experimental confirmation, they provide an useful work frame for building dual gamma ray and neutron detectors according to these packaging options.

In corndog design, ⁶Li glass does not provide shielding for gamma rays when it surrounds a rod made of NaI. For equivalent surface, a ⁶Li glass cylinder provides about twice the neutron counts and gamma ray background compared to a ⁶Li glass plate. When the neutron detector material is ⁶Li glass GS2 (that has an isotopic ratio of 95% ⁶Li and a total lithium composition of 2.4%), similar neutron count rate and gamma ray background are obtained as when the neutron detector material is ⁶Li glass GS20. A cylinder of surface equivalent to a studied plate provides more than eight times the neutron count rates of the commercially available far detector, but only four times the gamma-ray background. The ⁶Li glass plate design as well as an equivalent surface cylinder provides adequate neutron count rates for a near detector. A ⁶Li glass cylinder having the same dimensions as the commercially available far detector, filled with NaI does not provide enough gamma ray count rates for a far detector, but provides adequate gamma-ray count rates for a near detector.

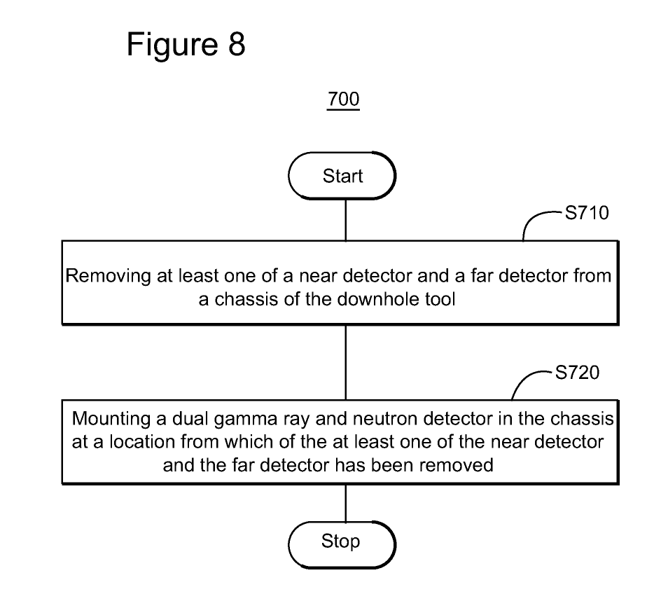

A conventional downhole tool with a neutron source and two neutron detectors may be retrofitted to replace one or both detectors with a dual gamma ray and neutron detector, respectively. FIG. 8 illustrates a flow diagram of a method 700 for retrofitting a conventional downhole tool. The method 700 includes removing at least one of a near detector and a far detector, at S710, and mounting a dual gamma ray and neutron detector in a location of a chassis of the downhole tool from which of the at least one of the near detector and the far detector has been removed, at S720. The dual gamma ray and neutron detector includes a first detection element made of a neutron detector material, and a second element made of a gamma ray scintillation material that are optically connected to a photomultiplier, and are formed to substantially fill a cylindrical shape. The first detection element may be made of ⁶Li glass and the second detection may be made of NaI. The first detection element and the second detection element may be formed according to any one of the above-described packaging options.

The disclosed exemplary embodiments provide packaging options for manufacturing a dual gamma-ray and neutron detector capable to operate at high temperature and in a harsh shock and vibration environment, using a neutron detector material and a gamma-ray detector material. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A dual gamma ray and neutron detector useable in a downhole tool for investigating composition of formation layers in a well, comprising:
a first detection element made of a neutron detector material;
a second element made of a gamma ray scintillation material; and
a photomultiplier optically connected to the first detection element and the second detection element, wherein the first detection element and the second detection element are formed to substantially fill a cylindrical shape.

2. The dual gamma ray and neutron detector of claim 1, wherein
the first detection element is a plate, and
the second detection element are half cylinders mounted on opposite sides of the plate, wherein layers of coupling grease or bond are disposed between the plate and the half cylinders.

3. The dual gamma ray and neutron detector of claim 1, wherein
the first detection element is a hollow cylinder, and
the second detection element is a rod placed inside the hollow cylinder.

4. The dual gamma ray and neutron detector of claim 1, wherein
the first detection element is a first cylinder, and
the second detection element is a second cylinder,
the first cylinder, the second cylinder and the photomultiplier being arranged along a common axis.

5. A downhole tool using a neutron source to determine characteristics of a formation surrounding a well, comprising:
a body configured to receive along a longitudinal axis
a neutron source that emits neutrons;
a near detector located at a first distance from a location of the neutron source; and
a far detector located at a second distance larger than the first distance from the location of the neutron source; and
at least one dual gamma ray and neutron detector serving as the near detector or as the far detector including
a first detection element made of a neutron detector material, and
a second element made of a gamma ray scintillation material,
the first detection element and the second detection element being optically connected to a photomultiplier.

6. The downhole tool of claim 5, wherein
the first detection element is a plate, and
the second detection element are half cylinders mounted on opposite sides of the plate.

7. The downhole tool of claim 6, wherein layers of coupling grease or bond are disposed between the plate and the half cylinders.

8. The downhole tool of claim 5, wherein
the first detection element is a hollow cylinder, and
the second detection element is a rod placed inside the hollow cylinder.

9. The downhole tool of claim 5, wherein
the first detection element is a first cylinder, and
the second detection element is a second cylinder,
the first cylinder, the second cylinder and the photomultiplier being arranged along a common axis.

10. The downhole tool of claim 9, wherein the second cylinder is located between the first cylinder and the photomultiplier.

11. The downhole tool of claim 5, wherein a light-guide element is placed between the photomultiplier and at least one of the first detection element and the second detection element.

12. The downhole tool of claim 5, wherein the detection elements are at least partially surrounded with a teflon wrapping.

13. The downhole tool of claim 5, wherein the at least one dual gamma ray and neutron detector is encased in a metallic shell.

14. The downhole tool of claim 5, wherein the metallic shell is made of titanium.

15. The downhole tool of claim 5, further comprising a quartz end cap located on a side opposite to where the photomultiplier is connected.

16. The downhole tool of claim 5, wherein the first detection element and the second detection element are formed to substantially fill a cylindrical shape.

17. The downhole tool of claim 5, wherein the first detection element is made of ⁶Li glass.

18. The downhole tool of claim 5, wherein the second detection element is made of NaI.

19. A method for retrofitting a downhole tool using a neutron source to determine characteristics of a formation surrounding a well, comprising:
removing at least one of a near detector and a far detector from a chassis of the downhole tool; and
mounting a dual gamma ray and neutron detector in the chassis at a location from which of the at least one of the near detector and the far detector has been removed,
the dual gamma ray and neutron detector including a first detection element made of a neutron detector material, and a second element made of a gamma ray scintillation material, wherein
(1) the first detection element and the second detection element are optically connected to a photomultiplier, and
(2) the first detection element and the second detection element are formed to substantially fill a cylindrical shape.

20. The method of claim 19, wherein (1) the first detection element is made of ⁶Li glass and the second detection is made of NaI, and (2) the first detection element and the second detection element are formed according to one of the following packaging options:
according to a first packaging option, the first detection element is a plate, and the second detection element are half cylinders mounted on opposite sides of the plate, with layers of coupling grease or bond are disposed between the plate and the half cylinders;
according to a second packaging option, the first detection element is a hollow cylinder, and the second detection element is a rod placed inside the hollow cylinder; and
according to a third packaging option, the first detection element is a first cylinder, and the second detection element is a second cylinder, the first cylinder, the second cylinder and the photomultiplier being arranged along a common axis.
